(19) United States
(12) Patent Application Publication
(10) Pub. No.: US 2012/0123121 A1
(43) Pub. Date: May 17, 2012

(54) SYNTHESIS OF PICOPLATIN

(75) Inventors: Alistair J. Leigh, Seattle, WA (US); Steffen Jost, Grundau (DE)

(73) Assignee: Poniard Pharmaceuticals, Inc., Seattle, WA (US)

(21) Appl. No.: 13/322,362

(22) PCT Filed: Jun. 11, 2010
(86) PCT No.: PCT/US10/38348

§ 371 Date: Feb. 2, 2012

Related U.S. Application Data
(60) Provisional application No. 61/186,526, filed on Jun. 12, 2009.

(51) Int. Cl. C07F 15/00

(52) U.S. Cl. 546/9; 546/12

(57) ABSTRACT

An improved method for the synthesis of the anticancer drug picoplatin is provided. Condensation of a tetrachloroplatinate salt (TCP), such as potassium tetrachloroplatinate, and 2-picoline, in a solvent, is catalyzed by the presence of oxygen, such as in air, and additionally catalyzed by the presence of a Pt⁺⁴ complex, such as potassium hexachloroplatinate. The oxygen can be introduced into the reaction mixture by sparging, optionally with high shear mixing and under an inert gas headspace. The product trichloropicolineplatinate salt (TCPP) is a key intermediate in the synthesis of picoplatin, to which it can be converted by reaction of the TCPP with ammonia.

### CROSS-REFERENCE TO RELATED APPLICATIONS

This application claims the priority of U.S. Ser. No.61/186,526, filed Jun. 12, 2009, which is incorporated herein by reference in its entirety.

### BACKGROUND

Picoplatin is a new-generation organoplatinum drug that has promise for treatment of various types of malignancies, including those that have developed resistance to earlier organoplatinum drugs such as cisplatin and carboplatin. Picoplatin has shown promise in the treatment of various kinds of cancer or tumor, including small cell lung cancer, colorectal cancer, and hormone-refractory prostate cancer.

Structurally, picoplatin is:

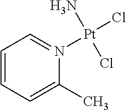

and is named cis-amminedichloro(2-methylpyridine)platinum(II), or alternatively [SP-4-3]-ammine(dichloro)(2-methylpyridine)platinum(II). The compound is a square planar complex of divalent platinum that is tetracoordinate and has three different ligand types. Two ligands are anionic, and two are neutral; therefore as the platinum in picoplatin carries a +2 charge, picoplatin is itself a neutral compound and no counterions need be present. The name “picoplatin,” referring to the presence of α-picoline (2-methylpyridine) in the molecule, is the United States Adopted Name (USAN), the British Approved Name (BAN), and the International Nonproprietary Name (INN) for this material. Picoplatin is also referred to in the literature as NX473, ZD0473, and AMD473, and is disclosed in U.S. Pat. Nos. 5,665,771, 6,518,428, and U.S. Ser. No. 10/276,503.

Picoplatin and processes for making picoplatin and for using picoplatin in treatment are disclosed and claimed in U.S. Pat. Nos. 5,665,771 (issued Sep. 9, 1997), and 6,518,428 (issued Feb. 11, 2003), and in PCT/GB0102060, filed May 10, 2001, published as WO2001/087313, which are incorporated herein by reference in their entireties. For example, in U.S. Pat. No. 6,518,428, a synthesis of picoplatin is disclosed wherein potassium tetrachloroplatinate is allowed to react with 2-picoline in N-methylpyrrolidone in the absence of any catalyst to yield potassium trichloropicolineplatinate, which can be reacted with ammonia to yield picoplatin.

### SUMMARY

The invention is directed to improved methods of synthesis of picoplatin from a tetrachloroplatinate salt (TCP) via an intermediate trichloropicolineplatinate (TCPP) salt. Various embodiments of a method of the invention provide for a higher yield and cleaner reaction product of the key intermediate TCPP than have been obtained by existing methods.

In various embodiments, the invention provides a method for conversion of a tetrachloroplatinate salt to a trichloropicolineplatinate salt, comprising contacting a dispersion of the tetrachloroplatinate salt and 2-picoline in an organic liquid, the dispersion further comprising effective amounts of oxygen and a Pt⁺⁴ complex respectively, wherein the oxygen is introduced into the dispersion by sparging oxygen gas or a gas mixture comprising oxygen gas therethrough, the dispersion being maintained at a temperature and for a period of time sufficient to provide the trichloropicolineplatinate salt. The Pt⁺⁴ complex can comprise a halide-containing anion such as hexachloroplatinate (HCP) salt. In various embodiments, the salts can all be potassium salts.

In various embodiments, the invention further provides a method for the conversion of a tetrachloroplatinate salt to picoplatin, comprising first carrying out the conversion of the tetrachloroplatinate salt to the trichloropicolineplatinate salt as described above, then, contacting the trichloropicolineplatinate salt with ammonia to provide picoplatin.

### DETAILED DESCRIPTION

### Definitions

“Picoplatin” refers to cis-amminedichloro(2-methylpyridine)platinum(II), or [SP-4-3]-ammine(dichloro)(2-methylpyridine)platinum(II) as the drug is also termed, the structure of which is

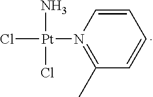

It is a compound belonging to the general class of redox-active metal complexes, in this case a complex of the third-row transition element platinum, the platinum being in the +2 oxidation state.

“Tetrachloroplatinate” or “TCP” refers to an anion of the formula PtCl₄⁻²

(TCP) which can be charge-balanced by any suitable cation, for example potassium. In tetrachloroplatinate, the platinum ion is divalent, Pt⁺². An example is K₂PtCl₄.

A “Pt⁺⁴ complex” refers to any complex containing a tetravalent Pt atom. The Pt ligands can all be the same, or can be different. For instance, ligands can include halides, amines, thiols, and the like. An example of a Pt⁺⁴ complex is a hexachloroplatinate (HCP) salt, such as potassium hexachloroplatinate, K₂PtCl₆. Further examples are tetravalent platinum species containing as ligands hydroxy, carboxylate, carbamate, or carbonate esters, or alkoxy, phosphonocarboxylate, diphosphonate or sulfate.

A “trichloropicolineplatinate salt” or “TCPP” refers to the compound obtained by replacing one and only one chloride of a tetrachloroplatinate salt with the neutral ligand 2-picoline. TCPP has the formula:

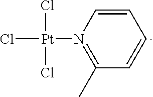

TCPP is a mono-anion which can be charge-balanced by any suitable cation, for example potassium. Reaction of this intermediate with ammonia, wherein a second chloride ligand is displaced by ammonia, yields the anticancer drug picoplatin.

“High-shear mixing” is a technique for preparing dispersions of fine particles in a liquid medium wherein high-shear conditions comminute coarser particles into finer ones in the presence of the liquid medium.

“Comminuting” or “milling”, as is well known in the art, refers to the physical grinding of a solid substance into a fine powder, which serves to increase the surface area per unit mass of the material.

“Contacting” as the term is used herein refers to disposing chemical substances in molecular proximity such that chemical reactions can take place, for example in solution, in a liquid/solid mixture, and bubbling gas mixtures into a liquid solution, wherein the liquid solution can also contain undissolved solid materials.

“Sparging” as the term is used herein refers to a process of introducing a gas into a solution, suspension, or dispersion whereby the gas stream is provided under sufficient pressure beneath the surface of the solution, suspension or dispersion, such that the gas bubbles into the medium and thereby contacts the constituents of the solution, suspension, or dispersion. Sparging can be carried out through a tube or other device that can convey the gas into the liquid, and the tube can be equipped with a frit or other device to control the average size of the gas bubbles emitted into the medium. The bubbles can be dispersed to provide a greater surface area of contact between the gas bubbles and the medium. The gas can be a gas mixture, such as an oxygen/nitrogen mixture. The pressure under which the gas is supplied can be only sufficient to overcome the head pressure of the medium, or it can be greater. Sparging can take place under conditions wherein the head space of the reaction vessel is filled with a gas different from the gas that is being sparged.

A “dispersion” as the term is used herein refers to a liquid medium, such as an organic liquid, wherein materials are dissolved, suspended, or both. A “suspension” refers to a liquid medium in which in a largely insoluble solid is mixed without dissolving to any great extent. A “solution” refers to a liquid medium in which a solid or liquid substance is dissolved in a homogeneous manner. Thus, a “dispersion” is both a solution and a suspension in which some materials are dissolved and some materials are suspended, or a solution, or a suspension.

A “liquid medium” is a liquid, commonly referred to as a solvent, but in which components do not necessarily dissolve, but can also be suspended. An “organic liquid” is such a material including an organic material, typically known as an “organic solvent” but in which all materials do not necessarily dissolve. Examples include N-methylpyrrolidone, N,N-dimethylformamide, dichloromethane, chloroform, ethanol, hexane, or the like.

An “effective amount”, or “effective amounts”, as the terms are used herein, means that the component referred to is present in a reaction mixture in an amount or at a concentration adequate to bring about the desired result, e.g., catalysis of the reaction. Specific effective amounts of various components herein are disclosed in the Specification.

### Description

In various embodiments, the invention provides a method for conversion of a tetrachloroplatinate salt to a trichloropicolineplatinate salt, comprising contacting a dispersion of the tetrachloroplatinate salt and 2-picoline in an organic liquid, the dispersion further comprising effective amounts of oxygen and a Pt⁺⁴ complex respectively, wherein the oxygen is introduced into the dispersion by sparging oxygen gas or a gas mixture comprising oxygen gas therethrough, the dispersion being maintained at a temperature and for a period of time sufficient to provide the trichloropicolineplatinate salt. It has been unexpectedly discovered by the inventors herein that oxygen and a tetravalent platinum complex serve to catalyze the formation of TCPP from TCP and, in fact, that under conditions of oxygen exclusion, the reaction does not proceed to any satisfactory extent.

In various embodiments, the oxygen can be contacted with the solution or dispersion as a component of a gas mixture. For example, the gas mixture can include nitrogen as a diluent, which can provide a greater level of safety when operating on a large scale than the use of pure oxygen gas. More specifically, the gas mixture can contain about 20% oxygen and about 80% nitrogen, the relative proportions as found in natural air. In various embodiments, the gas mixture is contacted with the solution by injecting the gas mixture under pressure into the solution, i.e., by “sparging”. In various embodiments, a total quantity of the gas mixture added to the solution contains about 0.3 to about 0.4 molar equivalents of oxygen relative to a molar amount of the tetrachloroplatinate salt.

In various embodiments, the reaction can be carried out at a concentration of about 25%, i.e., where for every gram of TCP, about 3-4 mL of the organic liquid is present in the reaction dispersion.

It has been discovered by the inventors herein that illumination of the reaction mixture with light, for example with ultraviolet light, is unnecessary and provides no catalytic effect in the conversion of the TCP salt to the TCPP salt.

In various embodiments, the tetravalent platinum complex, for example the hexachloroplatinate potassium salt, is present in the solution at about 0.05-0.2 wt % of a weight of the tetrachloroplatinate salt. When using a hexachloroplatinate salt, it can be added as a separate, pure material, or can be present as a known amount of an impurity in the TCP used in the reaction. TCP can be prepared from HCP, and commercial samples of TCP are known to often contain HCP as an impurity. The inventors herein have discovered that the HCP, when present as an impurity in the TCP starting material, can serve to catalyze the reaction yielding TCPP and assisting the reaction in proceeding to completion, i.e., complete consumption of the TCP starting material. Alternatively other tetravalent platinum complexes can be added, containing ligands such as another halide (e.g., bromide), amino, thio, hydroxy, carboxylate, carbamate, carbonate esters, alkoxy, phosphonocarboxylate, diphosphonate, or sulfate complexes.

In various embodiments of the invention, the 2-picoline can be present in the solution in an approximately 1.0-1.3 molar ratio with respect to starting TCP. No large molar excess is required to bring the reaction to completion under the inventive conditions.

In various embodiments, the tetrachloroplatinate salt, the hexachloroplatinate complex, or both, can be present in the reaction mixture as a potassium salt. When potassium salts are used, the product TCPP is also recovered in the form of a potassium salt. Other suitable cations, such as sodium, can also be used.

In various embodiments, the solvent comprises N-methylpyrrolidone, a polar aprotic solvent in which the product TCPP is soluble, but the byproduct KCl is not soluble to any great extent. Accordingly, byproduct KCl can be removed from the reaction mixture following conversion of the TCP to the TCPP by means of filtration, centrifugation, or other methods well known in the art for separating liquids from precipitated solids. For example, filtration through a 1 to 50 micron ceramic inline filter can be used.

In various embodiments, the temperature at which the TCP and the 2-picoline are contacted is about 60-80° C. More specifically, the temperature can be about 60-70° C.

In various embodiments, the period of time can be about 30 to about 240 minutes, or about 90 minutes to 150 minutes. More specifically, addition of the 2-picoline to a mixed dispersion of the TCP in the NMP and HCP, with oxygen gas mixture addition, can take place over about 90 minutes. The addition of the 2-picoline can begin after about 45 minutes of high shear mixing of the TCP in the solvent, and mixing and sparging can continue for about 90 minutes, followed by heating of the mixture, for example at about 65° C., for an additional 35 minutes after completion of the 2-picoline addition. Sparging can take place continuously or intermittently, at various stages during the reaction, provided a sufficient quantity of oxygen-containing gas is delivered to the reaction dispersion.

In various embodiments of the method of the invention, the process is particularly suited for use on a relatively large scale in closed reaction equipment. The process is suitable for carrying out the reaction on an industrial scale such as is used in pharmaceutical manufacturing, such as kilograms, tens of kilograms, or more. For example, a quantity of tetrachloroplatinate of least about 0.5 kg, or of at least about 2.0 kg, or of at least about 10 kg, can be used in the method. As the scale of the reaction is increased, the ratio of surface area to volume of the reaction dispersion decreases, making any residual headspace oxygen less and less suitable for catalyzing the reaction. Therefore, the introduction of the oxygen by sparging into the reaction dispersion enables the gas to function effectively as a catalyst by ensuring that suitable quantities are present. Sparging also allows the use of an inert headspace gas in the reaction equipment, which is advantageous from the perspective of safety.

In various embodiments of the invention, the tetrachloroplatinate salt can be a finely comminuted powder. Because the 2-picoline reagent is present in solution in the solvent, such as NMP with which it is miscible, a higher surface area to volume ratio of the solid TCP salt is desirable. Accordingly, methods of comminuting the TCP precursor including the use of ball or disc mills, as are well known in the art, can be used.

And, in various embodiments, high shear mixing of the reaction mixture can be employed. High shear mixing of the solid TCP salt in the liquid comprising the solvent and the 2-picoline can both decrease the average particle size of the TCP salt and can serve to expose fresh surfaces of the TCP salt, making them available for reaction with the 2-picoline. For example, high shear mixing can serve to remove occluding KCl formed by reaction of a surface layer of a TCP particle with 2-picoline, which is advantageous in that the KCl surface layer tends to reduce accessibility of the TCP to the 2-picoline and consequently reduces the rate and extent of completion of the desired reaction. High shear mixing can also serve to disperse the sparged oxygen gas mixture to maximize the surface area for oxygen adsorption and to provide for consistent operation.

In various embodiments, once reaction of the TCP and the 2-picoline is complete, the reaction dispersion can be processed to remove most of the byproduct KCl (or the corresponding inorganic salt obtained when other cations are used, such as NaCl), and unconverted TCP, as well as lowering HCP content to a level below 0.3% w/w relative to residual TCP, using methods well known in the art, such as filtration or centrifugation. For example, byproduct KCl and unreacted TCP can be removed by use of an inline filter on an outlet line of the reaction vessel in which the condensation of TCP and 2-picoline in a polar aprotic solvent such as NMP or DMF has taken place. More specifically, a ceramic frit or a metal (e.g., stainless steel) porous plate, or a depth filter, or a membrane filter, can be used. The filter can have any suitable porosity, for example, a filter medium having pores in the range from about 1 micron to about 50 microns can be used.

In various embodiments, the TCPP product can be recovered, for example from an NMP solution from which the KCl has been filtered out, by adding an organic liquid to provide a precipitated solid trichloropicolineplatinate salt. The organic liquid can be a solvent in which TCPP is insoluble, such as dichloromethane.

In various embodiments, the yield of the recovered TCPP salt in solid form is at least about 80%. In various embodiments, a residual wt % of the tetrachloroplatinate salt (TCP) in the precipitated solid trichloropicolineplatinate salt (TCPP) is no greater than about 0.5%. In various embodiments, a purity of the recovered trichloropicolineplatinate salt is no less than about 98%.

In various embodiments, picoplatin can be synthesized according to an embodiment of an inventive method by contacting the precipitated solid trichloropicolineplatinate salt with ammonia. The picoplatin product can be isolated and purified by methods such as are well known in the art.

For example, a three stage process that can be used to produce picoplatin by a method of the invention is outlined in Scheme 1, below. In Stage 1 of the process, the starting materials tetrachloroplatinate (TCP) and 2-picoline are allowed to react in the presence of oxygen and a Pt+4 complex such hexachloroplatinate complex to produce the intermediate trichloropicolineplatinate (TCPP). In Stage 2 the TCPP is reacted with ammonia to form the crude picoplatin. In Stage 3 the crude picoplatin is purified by recrystallization, then is isolated, washed, and dried to provide the picoplatin active pharmaceutical ingredient (API), useful for the treatment of cancer.

It has been unexpectedly discovered by the inventors herein that the presence of oxygen (O₂) is required for the reaction to proceed appreciably, and that a Pt⁺⁴ complex such as HCP is required to achieve consistent reaction completion. Both O₂ and HCP have surprisingly been found to have catalytic properties in this reaction. Both O₂ and the Pt⁺⁴ complex such as HCP are required to be present for the reaction between TCP and 2-picoline to proceed to completion at a technically acceptable rate.

The reaction chemistry is shown in Scheme 2.

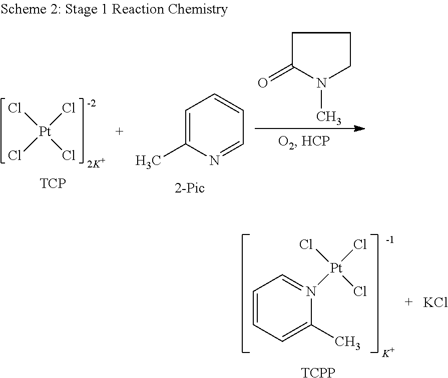

HCP is a well-known contaminant in commercial preparations of TCP, as one major manufacturing process for TCP involves reduction of HCP. It has been found that many commercial samples of TCP contain residual quantities of unreduced HCP. The inventors herein observed that in carrying out the condensation of TCP and 2-picoline, the reaction carried out under ambient atmospheric conditions proceeded more readily using batches of TCP containing detectable amounts of HCP that using batches that were substantially HCP-free. It has been found that a content of about 0.05 to 2 wt % HCP relative to TCP in the reaction mixture is advantageous, although amounts of HCP greater than about 0.3% are likely to be remain in a solid, undissolved form when the concentration of TCP in the organic liquid is in the range of about 25-33% w/v.

When the reaction was carried out under a nitrogen atmosphere, it was surprisingly observed that little or no reaction occurred between the TCP and the 2-picoline, even in the presence of HCP. Conversely, when an oxygen-containing gas mixture was bubbled (sparged) into the reaction mixture, the reaction rapidly proceeded to completion. When HCP was also present in the reaction mixture, the reaction proceeded even more completely and rapidly to provide a good yield and high purity of the desired product TCPP. The oxygen-containing gas mixture can be pure oxygen; however, for safety reasons at large scale a gas mixture made up of oxygen diluted with an inert gas such as nitrogen is advisable. For example, a 20% O₂/80% N₂ gas mixture can be employed for sparging. A total amount of gas can be introduced to provide a defined amount of O₂ to the reaction mixture. For example, about 0.3 equivalents of O₂ relative to TCP can be added to the solution containing the TCP and the 2-picoline. Dissolution of the oxygen in the reaction mixture can be facilitated by additional mixing or stirring.

The reaction mixture is agitated by the sparging of the gas, but it can be further mixed or stirred, such as with a paddle, or such as using high shear mixing techniques, as are well known in the art. Additional mixing, particularly high shear mixing, during the time period that gas sparging is occurring can assist in providing an increased contact between the gas bubbles and the reaction solution or dispersion, such that an effective dissolved concentration of oxygen can be more readily achieved.

The reaction need not be carried out under conditions of illumination, such as illumination with UV light. It may be that a certain amount of oxidation of platinum from the +2 to the +4 state assists in catalysis, or that some intervening platinum oxidation state is implicated. However, it has been found that HCP in the entire absence of oxygen is by itself ineffective as a catalyst, although in the presence of oxygen, added HCP does exhibit additional catalytic activity.

Table 1, below, shows a series of experiments directed at definition of the effects of moisture in the reaction solvent (NMP), light, and the presence or absence of oxygen on the reaction. The residual TCP, being unreacted starting material, is higher in reactions where poorer conversion to TCPP was observed.

TABLE 1
Effect of Light, and Oxygen on the Conversion of TCP to TCPP

| Light | Oxygen | Residual TCP % |
|---|---|---|
| Dark | Nitrogen | 98.6 |
| Dark | Oxygen | 6.4 |
| Light | Nitrogen | 99.1 |
| Light | Oxygen | 7.9 |
| Light | Oxygen | 2.3 |
| Dark | Oxygen | 3.3 |

Further experiments were carried out, as are shown graphically below in Graphs 1 and 2.

Graph 1 depicts a three-dimensional surface representing the yield of TCPP from TCP in a reaction using various embodiments of the inventive method. The yield is shown on the z-axis, as a function (mL air per gram TCP) of air (oxygen) added shown on the x-axis and added HCP (wt %) shown on the y axis.

As can be seen, very little product is obtained in the absence of air (oxygen). An optimal amount of air addition is around 20-25 mL per gm of TCP in the reaction mixture. However, the amount of HCP present also influences the TCPP yield. At a content of about 0.2 wt %, the yield is optimized relative to the amount of HCP added. It is apparent that oxygen by itself has a potent catalytic effect, HCP by itself is ineffectual, but HCP in the presence of oxygen adds to the catalytic activity present in the reaction mixture.

Graph 2 below depicts the amount of unreacted TCP detected in a reaction mixture under the conditions shown. Again, added air (mL synthetic air comprising 20% oxygen/80% nitrogen, per gram TCP) is shown on the x-axis, wt % HCP on the y-axis, and the percentage of unreacted TCP on the z-axis.

TABLE 2
Numerical Data for Yield versus Air, HCP content

| | HCP % | Air Flow | Air Flow | TCP % | Yield |
|---|---|---|---|---|---|
| Cond | TCP | (mL/h) | (mL/gTCP) | TCPP | [%] |
| 1 | 0.070 | 0 | 0.0 | 100.0 | 0.10 |
| 2 | 1.000 | 0 | 0.0 | 100.0 | 0.10 |
| 3 | 0.070 | 10 | 0.5 | 89.6 | 8.29 |
| 4 | 0.070 | 60 | 3.0 | 94.7 | 3.62 |
| 5 | 1.000 | 150 | 7.4 | 0.4 | 75.54 |
| 6 | 0.100 | 25 | 1.2 | 79.6 | 15.13 |
| 7 | 0.100 | 36 | 1.8 | 79.1 | 15.18 |
| 8 | 0.316 | 75 | 3.7 | 82.8 | 12.65 |
| 10 | 0.316 | 75 | 3.7 | 76.4 | 17.81 |
| 9 | 0.100 | 150 | 7.4 | 11.0 | 72.75 |
| 11 | 0.100 | 550 | 27.0 | 0.4 | 81.31 |
| 12 | 1.000 | 550 | 27.0 | 0.5 | 82.17 |
| 13 | 0.316 | 275 | 13.5 | 2.5 | 78.20 |
| 18 | 0.010 | 550 | 27.0 | 0.1 | 80.19 |
| 19 | 0.010 | 275 | 13.5 | 0.2 | 84.25 |
| 20 | 0.010 | 150 | 7.4 | 100.0 | 0.00 |
| 21 | 0.010 | 0 | 0.0 | 100.0 | 0.00 |
| 14 | 0.100 | 200 | 9.8 | 0.0 | 78.36 |
| 15 | 0.100 | 200 | 9.8 | 10.3 | 71.17 |
| 16 | 0.200 | 400 | 19.7 | 1.4 | 80.67 |
| 17 | 0.200 | 400 | 19.7 | 0.8 | 85.08 |
| | 0.010 | 0 | 0.0 | 0.0 | 0.0 |
| | 1.000 | 550 | 27.0 | 100.0 | 85.1 |

Graph 3, below, shows that HCP levels of about 0.1% w/w relative to TCP are sufficient to obtain a high degree of conversion of TCP to TCPP when the reaction is carried out on a small scale in NMP in the presence of air (oxygen). A study was performed with a series of homogeneous solution reaction systems in which HCP was spiked from 0.01 to 0.64% w/w relative to TCP. These reactions were performed at small scale in the presence of air. Samples were taken just before and after the addition of an aliquot of picoline. There was a rapid increase in the initial reaction rate from 0.01% w/w HCP to 0.04% w/w, then a smaller increase to a plateau by about 0.1% w/w. These studies show that HCP has a catalytic effect for the reaction of TCP with 2-picoline in the reaction solvent NMP and in the presence of air.

### EXAMPLES

### Example 1

### l Process Overview for Conversion of TCP to TCPP According to a Method of the Invention

### 1. Reactor Preparation and Charging

1.1. To a jacketed reaction vessel equipped with a high shear stirring apparatus charge 1-methyl-2-pyrrolidone (NMP).

1.2. Begin to heat the reactor contents to a target of 65° C. with agitation.

1.3. Charge potassium tetrachloroplatinate (TCP) and potassium hexachloroplatinate (HCP) to the reaction vessel with high shear agitator.

1.4. Initiate sparge of filtered air into the recirculation path of the high shear mixer.

### 2. Reaction

2.1. Begin addition of 2-picoline (2-Pic) 45 minutes after the addition of TCP to the reactor, and when the temperature is 65° C.

Add the 2-Pic continuously over 90 minutes into the reaction vessel.

Maintain agitation and the reaction temperature at 65° C. for 35 minutes.

Turn off the air sparge. Cool the reaction mixture.

### 3. Reaction Quench

3.1. Transfer the reaction mixture to the quench vessel by passing through an appropriately sized compatible filter.

3.2. Charge NMP to the reaction vessel to rinse the reaction mixture from the walls. Transfer the rinse through the filter and into the quench vessel, while maintaining the contents at 25° C.

3.3. Charge dichloromethane (DCM) to the quench vessel over 20 minutes, while agitating and maintaining the contents at 25° C. Continue to stir for up to 30 minutes after the addition of DCM.

### 4. Product Isolation and Washing

4.1. Filter the quenched reaction mixture through an appropriately sized compatible filter.

4.2. Resuspend the solids in DCM three times.

### 5. Product Drying

5.1. Dry the solids with agitation at 40° C. under vacuum.

TABLE 3
Process Material Usage

| | | | | | Total |
|---|---|---|---|---|---|
| | | Function | | | used or |
| | Abbr. | in | Formula | Molar | produced |
| Component | Name | Process | Weight | eq. | (kg) |
| Tetrachloroplatinate, | TCP | Starting | 415.08 | 1.00 | 1.00 |
| potassium salt | | Material | | | |
| Hexachloroplatinate, | HCP | Catalyst | 485.98 | 0.002 | 0.0020 |
| potassium salt | | | | | |
| 2-methylpyridine | 2-Pic | Starting | 93.13 | 1.1500 | 0.258 |
| (2-picoline) | | Material | | | |
| 1-methyl-2- | NMP | Solvent | 99.13 | N/A | 3.82 |
| pyrrolidone | | | | | |
| Water, purified | H₂O | Solvent | 18.00 | N/A | 0.035 |
| 20% O₂ 80% N₂ | Air | Catalyst | 28.8 | 0.360 | 0.0250 |
| (compressed) | | | | | |
| Dichloromethane | DCM | Solvent | 84.93 | N/A | 40.2 |
| TCPP | TCPP | Final | 433.65 | 80% | 0.84 |
| Calculated at 80% | | Intermediate | | Yield¹ | |
| Yield | | | | | |
| TCPP | TCPP | Final | 433.65 | 100% | 1.04 |
| Theoretical 100% | | Intermediate | | Yield¹ | |
| Yield | | | | | |

¹Yield from TCP;
N/A = Not Applicable.

While the invention has been described and exemplified in sufficient detail for those skilled in this art to make and use it, various alternatives, modifications, and improvements will be apparent to those skilled in the art without departing from the spirit and scope of the claims.

All patents and publications referred to herein are incorporated by reference herein to the same extent as if each individual publication was specifically and individually indicated to be incorporated by reference in its entirety.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method for conversion of a tetrachloroplatinate salt to a trichloropicolineplatinate salt, comprising contacting a dispersion of the tetrachloroplatinate salt and 2-picoline in an organic liquid, the dispersion further comprising an effective amount of oxygen wherein the oxygen is introduced into the dispersion by sparging oxygen gas or a gas mixture comprising oxygen gas therethrough, the dispersion being maintained at a temperature and for a period of time sufficient to provide the trichloropicolineplatinate salt.

2. The method of claim 1 further comprising providing an effective amount of a Pt⁺⁴ complex in the dispersion.

3. The method of claim 2 wherein the Pt⁺⁴ complex is a hexachloroplatinate salt.

4. The method of claim 1 wherein the gas mixture comprises oxygen and nitrogen.

5. The method of claim 4 wherein the gas mixture is natural air.

6. The method of claim 4 wherein the gas mixture comprises about 20% oxygen and about 80% nitrogen.

7. The method of claim 1 wherein a total quantity of the oxygen gas or gas mixture comprising oxygen gas introduced into the dispersion contains about 0.3 to about 0.4 molar equivalents of oxygen relative to a molar amount of the tetrachloroplatinate salt present in the dispersion.

8. The method of claim 7 wherein the dispersion is stirred during at least a portion of a period of time during which oxygen gas is introduced to assist in dissolution of the gas in the dispersion.

9. The method of claim 8 wherein stirring comprises high shear mixing.

10. The method of claim 1 wherein a volume in mL of the organic liquid is about 3-4 times a weight in grams of the tetrachloroplatinate salt.

11. The method of claim 2 wherein the Pt⁺⁴ complex is present in the dispersion at about 0.05-2.0 wt % of a weight of the tetrachloroplatinate salt.

12. The method of claim 1 wherein the 2-picoline is present in the dispersion in an approximately 1.0-1.3 molar ratio with respect to starting TCP.

13. The method of claim 1 wherein the tetrachloroplatinate salt, the Pt⁺⁴ complex, or both, is a potassium salt.

14. The method of claim 1 wherein the solvent comprises N-methylpyrrolidone.

15. The method of claim 1 wherein the temperature is about 60-80° C.

16. The method of claim 1 wherein the period of time is about 30 to about 150 minutes.

17. The method of claim 1 wherein the tetrachloroplatinate salt is a finely comminuted powder.

18. The method of claim 1 wherein contacting comprises high shear mixing.

19. The method of claim 1 comprising after the period of time has elapsed filtering the solution.

20. The method of claim 1 comprising after the period of time has elapsed optionally filtering the solution then adding a second organic liquid to provide a precipitated solid trichloropicolineplatinate salt.

21. The method of claim 20 wherein the second organic liquid comprises dichloromethane.

22. The method of claim 20 wherein a yield of the precipitated solid trichloropicolineplatinate salt is at least about 80%.

23. The method of claim 20 wherein a residual wt % of the tetrachloroplatinate salt in the precipitated solid trichloropicolineplatinate salt is no greater than about 0.5%.

24. The method of claim 20 wherein a purity of the trichloropicolineplatinate salt is no less than about 98%.

25. The method of claim 1 wherein the dispersion prior to the period of time comprises a quantity of tetrachloroplatinate of least about 0.5 kg.

26. The method of claim 1 wherein the dispersion prior to the period of time comprises a quantity of tetrachloroplatinate of at least about 2.0 kg.

27. The method of claim 1 wherein the dispersion prior to the period of time comprises a quantity of tetrachloroplatinate of at least about 10 kg.

28. The method of claim 1 wherein the dispersion is contained in a reaction vessel having an inert headspace gas disposed therein.

29. The method of claim 1 further comprising contacting the precipitated solid trichloropicolineplatinate salt with ammonia to provide picoplatin.
